(19) United States
(12) Patent Application Publication
(10) Pub. No.: US 2002/0120693 A1
(43) Pub. Date: Aug. 29, 2002

(54) E-mail conversion service

(76) Inventors: Michael L. Rudd, Fort Collins, CO (US); Jerlyn R. Culp, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/794,734

(22) Filed: Feb. 27, 2001

(51) Int. Cl. G06F 15/16

(52) U.S. Cl. 709/206

(57) ABSTRACT

The present invention provides a messaging system and methods for converting attachments to e-mails into a suitable format. The messaging system includes an e-mail server for receiving or sending an e-mail message for an intended recipient and a computer system including an e-mail client and a suite of software modules for processing data files having respective compatible data file formats. A trigger is provided for responding to a data file associated with an e-mail message and providing an indication that a data format of the data file associated with said e-mail message is not one of the compatible data formats. A data file converter, responsive to the trigger, selectively converts the data file associated with said e-mail message into one of the designated compatible data file formats.

### BACKGROUND

The exchange of electronic messages, or “e-mails,” between users of computer systems started several years ago. Originally, due to bandwidth, users typically only exchanged text messages in the body of the communication. With the meteoric rise in the use of the Internet as a means of exchanging business communications, computer systems have become more sophisticated in the types of files and information that can be sent via e-mail. Numerous e-mail applications or programs are currently available commercially. Many of these applications come from personal computer software companies. Examples include WORD PERFECT OFFICE™, LOTUS NOTES™, CCMAIL™, MICROSOFT MAIL™, etc. In computer conferencing a number of systems have also become available, including LOTUS NOTES EIES 2™, FIRST CLASS™, and SUPERKOM™. With today's systems, e-mail messages may now have large documents, presentations, pictures, or video feed being sent as attachments to the textual messages. While this form of communication is now widespread, a number of problems remain in its utilization.

One predominant problem in using e-mail communications to correspond is in the incompatibility between the systems or software of the mail sender and the mail receiver. As will be appreciated by one of ordinary skill in the art, frequently, a receiver of an e-mail message will be unable to open and view an attachment because the software application in which the attachment was created is not compatible with the software accessible by the receiver. In such circumstances, formatting problems are commonplace, and worse, oftentimes the receiver cannot edit, or even view, the attachment. For the receiver to view the attachment, the attachment must be converted from its original software application into an application which is accessible to the receiver. After conversion, the receiver may be able to view and/or edit the attachment. However, for example, if the receiver edits the attachment and sends the changes to the original sender as an attachment in the receiver's chosen software platform, similar conversion problems may exist on the original sender's end.

Compatibility problems surface in two different situations. First, compatibility problems may exist between different versions of the same software. For example, a receiver of an e-mail message having an attachment in a newer version of a software application the receiver has on its computer may result in the receiver being unable to edit or even view the attachment when the attachment is not backward compatible with the earlier version. Secondly, compatibility problems may exist between different platforms or software packages. For example, as will be appreciated by one of ordinary skill in the art, a user having Microsoft products on its system who receives an e-mail having an attachment in LOTUS AMIPRO™ may be unable to read or edit the attachment if the user does not also have AMIPRO™ on its system. Likewise, it will be appreciated that a user working with certain Microsoft products for PC's who receives an e-mail message from a sender using Microsoft products for Macintosh may be unable to read or edit the attachment. In any case, the common problem of computer systems becoming “locked-up” or crashing from trying to read incompatible files remains rampant in the industry.

Prior artisans have continuously searched for solutions to the above problems in the art. In some instances, receivers and senders, particularly those within the same organization, simply agree upon a common format for attachments which are to be communicated via e-mail. Unfortunately, several problems still exist. For example, coordination ahead of time is sometimes difficult. In some instances, the incompatibility between versions may arise because certain individuals within an organization are using updated software before others. Also, although those within the same organization may agree upon common software, outside e-mails may still result in the above-described incompatibility problems.

In some instances, computer users attempt to keep numerous software packages on their systems in an effort to have access to platforms in which attachments may arrive. However, this solution is unsuitable because of the inordinate expense involved with purchasing software and keeping the software updated for conversion into any needed version. Likewise, this solution is unsuitable because of the limited amount of memory on many systems which cannot support the loading of voluminous software packages. Purchasing and updating software (in combination with the loss of memory space) is unattractive to most users if the need for the software to access an e-mail attachment is infrequent.

In some instances, computer users may have different software loaded on the local hard drives of different computers throughout a common network. In such cases, when a receiver of an e-mail needs an attachment converted, the receiver forwards it to the individual computer having compatible software for viewing the attachment or converting the attachment into a platform the receiver's computer can utilize. As will be appreciated by one of ordinary skill in the art, this solution is unsuitable not only because of the unattractive need for purchasing and updating of software as discussed above, but also the obvious problems stemming from the excessive manual intervention needed to send and convert files, the potential loss of data, and the potential inability of the receiver to be able to communicate back to the original sender in a compatible format.

### SUMMARY OF THE INVENTION

The present invention overcomes many of the practical problems described above and offers new advantages as well. According to the invention there is provided a conversion service for converting attachments to e-mails sent to a client of the service into a format readable by the client. Also, according to the invention there is provided a system utilizing the conversion service. In addition, according to the invention there are provided methods of using the system and service.

“E-mail” is intended to refer to electronic messaging systems, including, but not limited to, those that use Simple Mail Transfer Protocol (SMTP) for sending electronic messages between servers and/or from a mail client to a mail server, and Post Office Protocol (POP) or Internet Message Access Protocol (IMAP) for requesting and sending electronic messages from a mail server to a mail server.

“Client” is intended to refer to either the “e-mail” client application that enables receipt and transmission of e-mail; the client part of a client-server architecture, typically an application that runs on a personal computer or workstation and relies on an associated server to perform certain operations; and/or the platform on which the client runs, the meaning being clear to one of ordinary skill in the art from context of use.

“Subscriber”, “user”, and “intended recipient” are generally used to mean a person or operator of the e-mail client or associated application programs, utilities, etc. running on the associated PC or workstation, including a person or system to whom an e-mail message is addressed.

According to one aspect of the invention, a messaging system includes an e-mail server configured to receive and/or send an e-mail message for an intended recipient, e.g., a particular e-mail client. A computer system (e.g., the client or user's PC) includes an e-mail client and a suite of software modules (e.g., application programs) configured to process data files having respective compatible data file formats. A trigger, for example, located at the e-mail client or server, is responsive to a data file associated with the e-mail message (e.g., an attachment such as a word processing or spreadsheet data file) and is configured to provide an indication that a data format of the received data file is not one of the compatible data file formats, i.e., an incompatible or a non-preferred format. A data file converter responds to the trigger to selectively convert the received data file into one of the compatible data file formats.

According to another aspect of the invention, a method of operating a messaging system includes saving or storing a listing of compatible data file formats acceptable to an intended recipient of an e-mail message. After receiving an e-mail message for an intended recipient (e.g., e-mail client machine), at least one file associated with the e-mail (e.g., an attachment) is examined to identify a data file format of the file. Compatibility of the file is assessed by determining if the data file format of the file is included in the listing of the compatible data file formats. If incompatible, the file is transmitted to a remote conversion service accessible, for example, on a LAN, WAN or via the Internet. In addition to transmitting the file, the desired file format (i.e., one of the compatible data file formats) is designated as the target format of the file. The file is then converted and the converted file is forwarded to the intended recipient via, e.g., the e-mail server and/or client.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope in the invention as set forth in the appended claims.

### BRIEF DESCRIPTION OF THE DRAWING

For a more complete understanding of the present invention, reference is now made to the following descriptions taken in conjunction with the accompanying drawing, in which:

FIG. 1 is a block diagram of one embodiment of an e-mail system using the conversion service according to the invention;

FIG. 2 is a block diagram of an alternate embodiment of an e-mail system using the conversion service according to the invention;

FIG. 3 is another block diagram of another alternative embodiment of an e-mail system using the conversion service according to the invention; and

FIG. 4 is another block diagram of another alternative embodiment of an e-mail system using the conversion service according to the invention.

### DETAILED DESCRIPTION

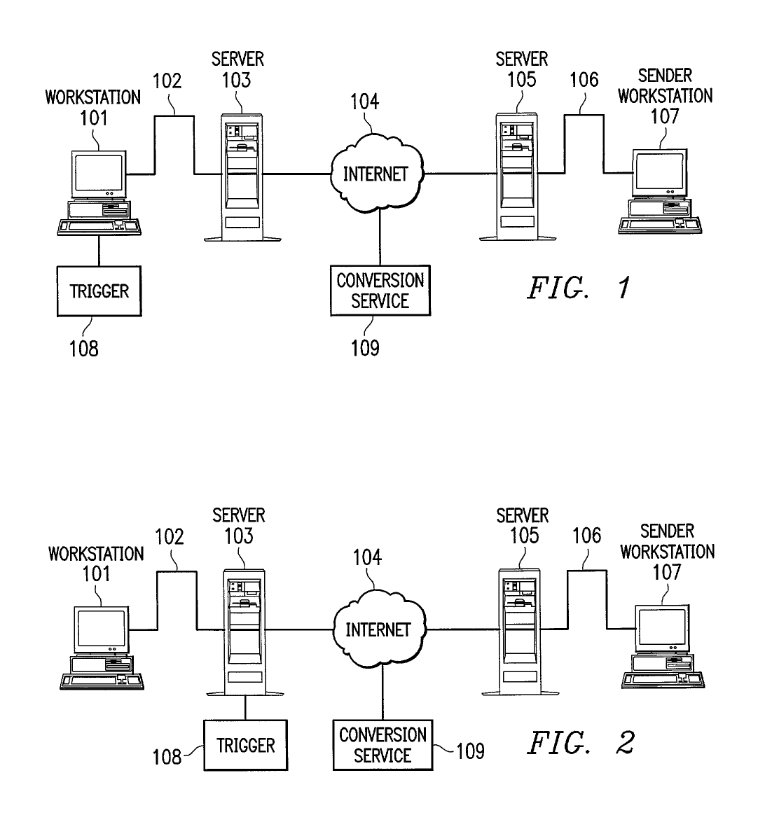

In accordance with a presently preferred embodiment, FIG. 1 depicts e-mail system 100 for communication between personal computers. As shown in FIG. 1, e-mail system 100 comprises personal computer or workstation 101 running appropriate e-mail client software and in communication with e-mail server 103 via connection 102. As will be appreciated by one of ordinary skill in the art, connection 102 may be a dedicated connection, telephone line, wide-area network (WAN) or a local area network (LAN).

E-mail server 103 is in communication with Internet 104 by any suitable means, such as via an Internet Service Provider (ISP). Also in communication with Internet 104 is e-mail server 105. E-mail server 105 has connection 106 for communication with sender workstation 107. It will be appreciated that connection 106 may also a dedicated connection, telephone line, WAN or LAN and that the phrase “sender” is used in the present example to designate a source or originator of an e-mail addressed to workstation 101.

In communication and accessible with Internet 104 is conversion service 109. Conversion service 109 comprises a processor platform (e.g., remote computer system) and software configured to convert one data format into another desired data format. In a presently preferred embodiment, the conversion service is run by a company which provides data conversion for a fee. The company and its service according to this embodiment are accessed through the Internet. Accessing the company's web site and registering as a subscriber of the service allows a subscriber to have e-mail attachments received by the subscriber converted from an incompatible or undesired format into another compatible or desired format.

Associated with conversion service 109 is trigger 108. Trigger 108 preferably comprises trigger software a subscriber receives and installs as part of or in association with the e-mail client software or the associated e-mail server after registering for the service. Trigger software according to the invention is configured to identify data formats compatible with personal computer or workstation 101. Preferably, trigger 108 also allows a user to identify data formats, which although compatible with personal computer or workstation 101, the user does not wish to receive as attachments. More preferably, trigger 108 or conversion service 109 allows a user to specify the conversion format in which the user desires to have attachments converted.

Trigger 108 preferably performs a gate-keeping function. When an e-mail with an attachment arrives at personal computer or workstation 101, trigger 108 preferable scans the attachment to determine whether it is composed in a format compatible with applications available on or to personal computer or workstation 101. If the format of the attachment is compatible, trigger 108 preferably does nothing or allows the e-mail and attachment to be processed normally. However, if the attachment is incompatible (or if the attachment is in a format the user has indicated as not being desirable for attachments), trigger 108 preferably sends the attachment back through network 101 to e-mail server 103 for deposit through Internet 104 with conversion service 109 for conversion into a compatible or desired format. Alternatively, trigger 108 may simply notify subscriber that an e-mail having an incompatible attachment has been received and prompt the subscriber to indicate whether or not to have the attachment converted by conversion service 109.

Conversion service 109, preferably in conjunction with trigger 108, may perform additional functions. For example, conversion service 109 may provide billing information when returning an attachment to a user. Likewise, conversion service 109 may provide a client with the original attachment which was forwarded for conversion, or perform other functions on the attachment such as virus scanning, or automatically archive a copy of the attachment. As will be appreciated, maintaining the original e-mail may be important for legal reasons. Conversion service 109 may also provide the original sender an indication that the service was necessary to convert the attachment, and inform the original sender as to the converted format. In addition, conversion service 109 may automatically re-convert a converted attachment being sent from the subscriber to the original sender back into its original format. Preferably, conversion service 109 also performs functions such as virus scanning and automatic archival of files.

With reference to FIG. 1, the system of this embodiment operates as follows. A sender initiates an e-mail message from sender workstation 107 destined for a subscriber at personal computer or workstation 101. The message contains an attachment in original format language. The message travels through connection 106 to e-mail server 105. E-mail server 105 is in communication with Internet 104. Also, in communication with Internet 104 is e-mail server 103. Internet 104 passes the message to e-mail server 103 through conventional channels using, for example, SMTP. E-mail server 103 sends the message through connection 102 to personal computer or workstation 101 using, for example, POP or IMAP to transfer the message to the associated e-mail client software.

Residing on personal computer or workstation 101 is trigger 108. Trigger 108 determines if the attachment is in a compatible or desired format. If so, the message and attachment are presented to the subscriber in their ordinary course. If not, trigger 108 notifies the subscriber that a message with an attachment in an incompatible or undesired format has been received. The subscriber then decides whether or not to forward the attachment to conversion service 109 for conversion into a suitable format. Alternatively, trigger 108 automatically sends the attachment to conversion service 109, and preferably notifies the subscriber that an attachment has been sent to conversion service 109.

After trigger 108 instructs the e-mail client of personal computer or workstation 101 to send the attachment to conversion service 109, the attachment (with or without the associated message) passes through connection 102 to e-mail server 103. E-mail server 103 accesses conversion service 109 through Internet 104. Conversion service 109 converts the attachment into a suitable format for return to personal computer or workstation 101 and the e-mail client. Alternatively, other, non-e-mail based means may be used to transmit the attachment to conversion service 109 including, for example, FTP or HTTP.

The “suitable format” may be chosen in a number of ways. For example, conversion service 109 based on information provided by trigger 108 may default to a conversion format accessible by personal computer or workstation 101 that is also commonly used for conversion of the original format. Alternatively, conversion service 109 may be instructed by subscriber, through information provided to trigger 108 or directly to conversion service 109, of a particularly desired conversion format to use with certain data formats or all formats. In another alternative, if personal computer or workstation 101 running the e-mail client software lacks the ability to access an attachment regardless of the format (i.e.,-if the attachment includes graphics that client computer cannot view in any format), the conversion service 109 may convert the original format into hyper-text mark-up language (HTML) and provide the client with a URL accessible through the Internet for viewing the attachment. This feature may be particularly important if the receiver is an “Internet appliance” or other web browser device. As will be appreciated by one of ordinary skill in the art, there are a number of ways to provide converted attachments to the subscriber and to choose the conversion language for the attachment, each should be viewed as within the scope of the invention.

After conversion into a suitable format, conversion service 109 sends the converted attachment, with or without the original attachment, through Internet 104 to e-mail server 103 for presentation to personal computer or workstation 101 through connection 102. Alternatively, conversion service provides a message to personal computer or workstation 101 as to the URL where the attachment in HTML may be viewed using an appropriate browser or browser functionality of the e-mail client. Conversion service 109 may also provide messages to sender workstation 107 to inform the sender that the attachment is being converted by or for the subscriber.

Alternatively, the sender may be able to send the message and attachment directly to conversion service 109 on behalf of the subscriber and have the attachment converted into a suitable format before the message is sent to e-mail server 103 through Internet 104.

In another alternative, after subscriber views and/or edits the converted attachment, the client may need to send the attachment back to the sender. In this embodiment, the conversion service 109 may be used to re-convert the converted attachment back to its original format prior to return to the sender. The conversion may be by direction of the subscriber or occur automatically by operation of trigger 108 and/or conversion service 109. Preferably, both subscriber and sender are users of conversion service 109 and the conversions back and forth take place automatically as part of the service.

FIG. 2 depicts another presently preferred embodiment of the system according to the invention. In this embodiment, trigger 108 is provided on e-mail server 103. As will be appreciated by one of ordinary skill in the art, provision of trigger 108 on e-mail server 103 may be particularly advantageous for large corporate or other organizations desiring conformity and ease of use. Other advantages may also be realized by provision of trigger 108 on e-mail server 103. For example, the information which trigger 108 provides to conversion service 109 as to the compatibility and desirability of formats is much easier to maintain and update when the server serves the entire organization instead of having each individual client PC provide its own parameters to the service. This prevents attachments which are only accessible by a few in the organization from being used to the exclusion of others. For example, in passing a large PowerPoint presentation back and forth between authors, if one is using an outdated or unauthorized format, formatting problems, loss of data, and like problems may occur. Likewise, in updating software with new versions and the like, obsolescence information is much easier to track and control when e-mail server 103 acts as a gate-keeper for the entire organization.

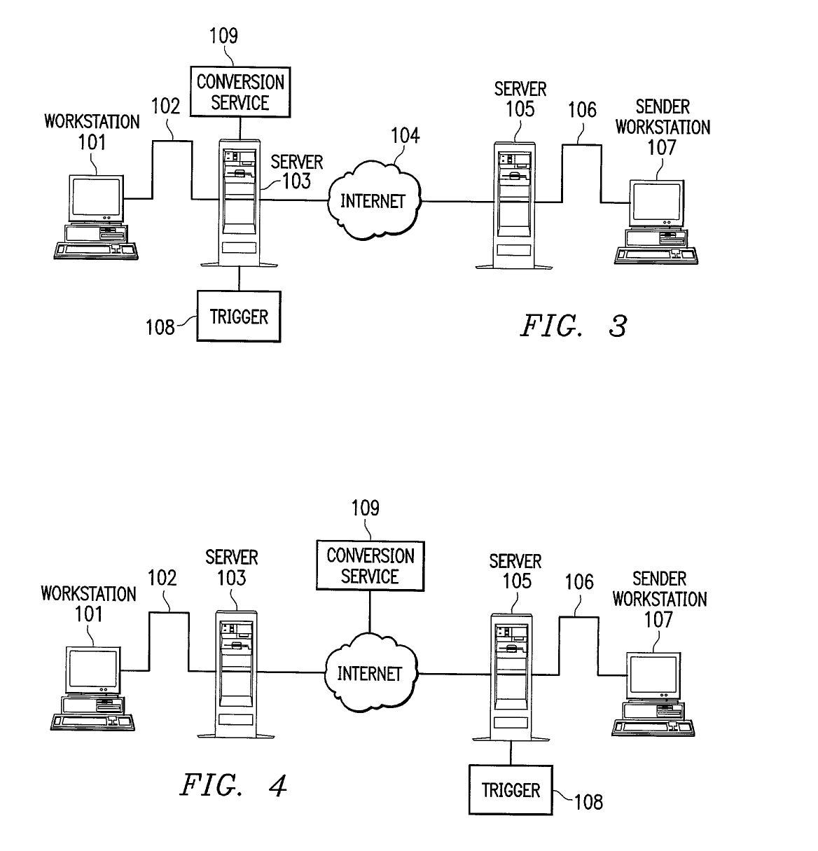

FIG. 3 depicts yet another presently preferred embodiment of the system according to the invention. In this embodiment, both trigger 108 and conversion service 109 reside on e-mail server 103. Although trigger 108 may reside on personal computer or workstation 101 when conversion service 109 is provided on e-mail server 103, the advantages of providing both on the e-mail server become apparent.

In the embodiment depicted in FIG. 3, conversion service 109 comprises software residing on the same platform (e.g., computer) as e-mail server 103. Conversion service 109 still performs the format conversion functionality described above, however, provision of the service on e-mail server 103 does away with the need to access the service through Internet 104. Not using Internet 104 as a medium for passing attachments may be particularly desirable when encryption or secrecy is involved. One of ordinary skill in the art will appreciate the desirability of allowing format conversion to take place without having to leave the connection 102 and access a third-party service through Internet 104. Likewise, with the provision of conversion service 109 on the same platform as e-mail server 103, one of ordinary skill in the art will appreciate the desirability of providing trigger 108 as a gate-keeper as part of e-mail server 103.

FIG. 4 depicts another embodiment of the present invention. Unlike the embodiments shown in FIGS. 1-3, the embodiment of FIG. 4 has trigger 108 on the sender's side of Internet 104. Specifically, in this embodiment, trigger 108 resides on server 105. One of ordinary skill in the art will appreciate that it may be desirable for organizations and subscribers to have the ability to have attachments converted into a desired file format, which the sender knows is necessary to allow the addressee of the e-mail to view or read the attachment, before the attachment is sent over the Internet 104 to workstation 101.

For example, sender workstation 107 sends an e-mail having an attachment in a file format resident on sender workstation 107 to an addressee which may not be able to view that format. The attachment is transmitted by connection 106 to server 105, where trigger 108 determines that the addressee needs the attachment converted into another format. Trigger 108 may determine the need for conversion based on information regarding addressees stored on server 105, or based on instructions provided by sender in connection with the e-mail. Trigger 108 may be dynamically updated by, for example, server 105 initiating a query to an appropriate database. In any event, the attachment is sent via Internet 104 to conversion service 109. Conversion service 109 converts the attachment into a suitable format and forwards the converted file to workstation 101.

Alternatively, both trigger 108 and conversion service 109 may reside on server 105 in a manner somewhat analogous to FIG. 3. Likewise, trigger 108 may reside on sender workstation 107 while conversion service 109 remains accessible through Internet 104 in a manner somewhat analogous to FIG. 1. As will be appreciated by one of ordinary skill in the art, the provision of trigger 108 and conversion service 109 may be at any suitable location in the system to accomplish the purposes of the invention. For example, the placement of trigger 108 and conversion service 109 may depend on whether the subscriber is an institution or organization operating on a common server. According to the invention, organizations may be able to purchase special software which allows the trigger 108 and conversion service 109 to reside on the company's server. By contrast, for individual subscribers who do not have a common server, for example, individuals working from their home PCs, the placement of trigger 108 may be at sender workstation 107 and configured to access conversion service 109 (via Internet 104) based on the individuals preferences and needs. In this example, although not shown, trigger 108 on sender workstation 107 identifies that an attachment addressed to an addressee is in a format that needs to be converted for that addressee. The attachment is forwarded to an Internet web-site which allows access to conversion service 109. The conversion service 109 converts the format of the attachment according to information provided by the subscriber or provided with the attachment to be converted and forwards the converted file to the addressee or addressees in the case of multiple recipients.

It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

What is claimed is:

1. A messaging system, comprising:
an e-mail server configured to receive an e-mail message for an intended recipient;
a computer system including an e-mail client and a suite of software modules configured to process data files having respective compatible data file formats;
a trigger responsive to a data file associated with said e-mail message and configured to provide an indication that a data format of the data file associated with said e-mail is not one of said compatible data file formats; and
a data file converter responsive to said trigger and configured to selectively convert the data file associated with said e-mail message into one of said compatible data file formats.

2. The messaging system according to claim 1 wherein said data file converter is further responsive to a user input for selecting said one of said compatible data file formats into which said data file associated with said e-mail message is to be converted.

3. The messaging system according to claim 1 wherein said e-mail client implements one of Post Office Protocol (POP) and an Internet Message Access Protocol (IMAP).

4. The messaging system according to claim 1 wherein said trigger is implemented by said computer system and said data file converter is connected to said computer system via a packet data communications network.

5. The messaging system according to claim 1 further comprising:
a data network; and
a remote processor hosting said data file converter and connected to said data network,
wherein said e-mail server is also connected to said data network for receiving said e-mail message and said trigger is implemented by said computer system such that receipt by said e-mail server of a non-compatible file format causes said data file converter to convert the data file associated with said e-mail message into one of said compatible data file formats.

6. The messaging system according to claim 5 wherein said data network comprises the Internet.

7. The messaging system according to claim 1 wherein said trigger is implemented on said e-mail server.

8. The messaging system according to claim 7 wherein said e-mail server and said data file converter are implemented on a common processing platform.

9. The messaging system according to claim 7 wherein said data file converter is implemented on a remote platform connected to said e-mail server via a packet data communications network.

10. The messaging system according to claim 1 wherein said trigger is responsive to one of a Multipurpose Internet Mail Extensions (MIME) and Uuencode portion of said e-mail message and said e-mail server operates in accordance with Simple Mail Transfer Protocol (SMTP) to receive said e-mail message.

11. The messaging system according to claim 1 wherein said data file converter is configured to receive a response from the intended recipient, selectively process said data file associated with said e-mail message, and transmit the processed data file in a predetermined data format.

12. The messaging system according to claim 11 wherein said processing includes editing of said data file associated with said e-mail message and said predetermined data format is said data format of said received file prior to conversion.

13. The messaging system according to claim 1 further comprising:
a database associating with said computer system designations of said compatible data file formats, wherein said computer system further includes logic configured to automatically initiate an update of said database in response to a change of said compatible data file formats.

14. A messaging system, comprising:
an e-mail server configured to send an e-mail message for an intended recipient;
a computer system including an e-mail client and a suite of software modules configured to process data files having respective compatible data file formats;
a trigger responsive to a data file associated with said e-mail message and configured to provide an indication that a data format of the data file associated with said e-mail message is not one of said compatible data file formats; and
a data file converter responsive to said trigger and configured to selectively convert the data file associated with said e-mail message into one of said compatible data file formats.

15. The messaging system of claim 14 further comprising:
a data network; and
a remote processor hosting said data file converter and connected to said data network,
wherein said e-mail server is also connected to said data network for sending said e-mail message and said trigger is implemented by said computer system such that receipt by said e-mail server of a non-compatible file format causes said data file converter to convert the data file associated with said e-mail message into one of said compatible data file formats.

16. A method of operating a messaging system, comprising the steps of:
storing a listing of compatible data file formats acceptable to an intended recipient of an e-mail message;
receiving an e-mail message for an intended recipient;
examining at least one file associated with said e-mail message to identify a data file format thereof;
determining if said data file format of said at least one file is included in said listing of said compatible data file formats;
transmitting, in response to said determining step, said at least one file to a remote conversion service;
designating to said remote conversion service a desired one of said compatible data file format into which said at least one file is to be converted;
converting said at least one file into said desired file format; and
forwarding said file converted into said desired file format to said intended recipient.

17. The method according to claim 16 further comprising a step of processing the forwarded file with an application program run by said intended recipient.

18. The method according to claim 16 wherein said receiving step is performed according to one of Post Office Protocol (POP) and an Internet Message Access Protocol (IMAP).

19. The method according to claim 16 wherein said determining step is performed by said intended recipient.

20. The method according to claim 16 further comprising the steps of:
storing an original copy of said at least one file prior to said step of converting;
receiving a response from said intended recipient;
processing said original copy of said at least one file in accordance with said response; and
transmitting the processed copy of said at least one file.
